(19) United States
(12) Patent Application Publication
(10) Pub. No.: US 2015/0316781 A1
(43) Pub. Date: Nov. 5, 2015

(54) IMAGE PROJECTION APPARATUS

(71) Applicant: CANON KABUSHIKI KAISHA, Tokyo (JP)

(72) Inventor: Yuuki Maeda, Utsunomiya-shi (JP)

(21) Appl. No.: 14/697,997

(22) Filed: Apr. 28, 2015

(30) Foreign Application Priority Data
May 2, 2014 (JP) 2014-095055
Apr. 16, 2015 (JP) 2015-084533

(51) Int. Cl. G02B 27/28; G02B 1/00; H04N 5/74; H04N 9/31

(52) U.S. Cl. CPC G02B 27/283; H04N 9/3167; G02B 1/00; H04N 5/7441; G02B 3/0056

(57) ABSTRACT

A lead-free image projection apparatus capable of further reducing generation of black floating and color unevenness includes a reflective display element configured to modulate incident illumination light and to emit the light thus modulated, a projection optical system configured to project the light thus modulated, and a polarizing beam splitter configured to guide the illumination light to the reflective display element and to guide a predetermined polarization component of the light thus modulated to the projection optical system. The beam splitter includes a lead-free glass member and satisfies predetermined conditional expressions.

### BACKGROUND OF THE INVENTION

1. Field of the Invention

The present invention relates to an image projection apparatus including a reflective display element.

2. Description of the Related Art

An image projection apparatus including a reflective display element separates white light from a light source into a plurality of constituent color beams and guides them to corresponding display elements, or synthesizes color beams from a plurality of display elements, by using a polarizing beam splitter that transmits or reflects each light beam depending on polarization of the light beam.

A typical polarizing beam splitter includes a polarization separating layer and an adhesion layer between two glass members. Any birefringence due to stress generated inside the glass members disorders polarization, which causes defects such as black floating (misadjusted black level or lighter black display) and color unevenness to an image projection apparatus that performs a high luminance. The defects are reduced by the use of a lead-containing glass member having a low photoelastic constant to ensure low light absorption. For example, U.S. Pat. No. 5,808,795 discloses a polarizing beam splitter that includes a glass member having a photoelastic constant of 1.5 cm²/N or less to reduce the polarization disorder due to stress.

U.S. Pat. No. 7,258,445 discloses a polarizing beam splitter with selective absorptivities of components other than the glass members (the polarization separating layer and the adhesion layer) to absorb light.

### SUMMARY OF THE INVENTION

The present invention provides an image projection apparatus including a reflective display element configured to modulate illumination light from a light source and to emit the light thus modulated, a projection optical system configured to project the light thus modulated onto a projection surface, and a polarizing beam splitter configured to guide the illumination light to the reflective display element and to guide a predetermined polarization component of the light thus modulated to the projection optical system. The polarizing beam splitter is a polarizing beam splitter that blue-band light enters, includes a lead-free glass member, and satisfies conditional expressions below:

50<α*E*β*A/κ<300

A=(1−T̂(L/0.01))+M

T=(T1+T2)/2

where α represents a linear expansion coefficient (10⁻⁷/K) of the glass member, E represents a Young's modulus (10⁹ Pa) of the glass member, β represents a photoelastic coefficient (10⁻¹²/Pa) of the glass member, A represents an absorptivity of the polarizing beam splitter for blue-band light, κ represents a thermal conductivity (W/mK) of the glass member, L represents a distance from an incident surface to a first exit surface of the polarizing beam splitter, M represents an absorptivity of a member other than the glass member on an incident optical path in the polarizing beam splitter for light having a wavelength of 440 nm, T1 represents a transmissivity of the glass member having a thickness of 10 mm for light having a wavelength of 420 nm, and T2 represents a transmissivity of the glass member having a thickness of 10 mm for light having a wavelength of 460 nm. The incident surface is a surface of the polarizing beam splitter, which the illumination light entering the polarizing beam splitter from the light source passes through. The first exit surface is another surface of the polarizing beam splitter, which the illumination light emitted from the polarizing beam splitter passes through. The incident optical path is an optical path on which the illumination light travels from the incident surface to the first exit surface. The distance from the incident surface to the first exit surface is a sum of a length of the glass member from the incident surface to the member other than the glass member on the incident optical path, and a length of the glass member from the member other than the glass member to the first exit surface on the incident optical path.

Further features of the present invention will become apparent from the following description of exemplary embodiments with reference to the attached drawings.

### BRIEF DESCRIPTION OF THE DRAWINGS

FIG. 1 illustrates a configuration of an image projection apparatus according to a first embodiment of the present invention.

FIG. 2 is a pattern diagram of a structure of a polarizing beam splitter according to the first embodiment.

FIG. 3A is an optical path diagram of white display, and FIG. 3B is an optical path diagram of black display according to the first embodiment.

FIG. 4 illustrates a configuration of an image projection apparatus according to a second embodiment of the present invention.

FIG. 5 is a pattern diagram of a structure of a polarizing beam splitter according to the second embodiment.

### DESCRIPTION OF THE EMBODIMENTS

Recent growing interest in environmental issues urges development of a lead-free image projection apparatus that projects a high luminance image.

Any stress generated in a polarizing beam splitter causes lighter black display and color unevenness, but the absorptivity and thermal conductivity of a glass member, which affect the stress generation, have not been considered in the development so far.

The present invention provides a lead-free image projection apparatus capable of further reducing generation of black floating and color unevenness.

Exemplary embodiments of the present invention will be described below with reference to the accompanied drawings.

### First Embodiment

### Image Projection Apparatus

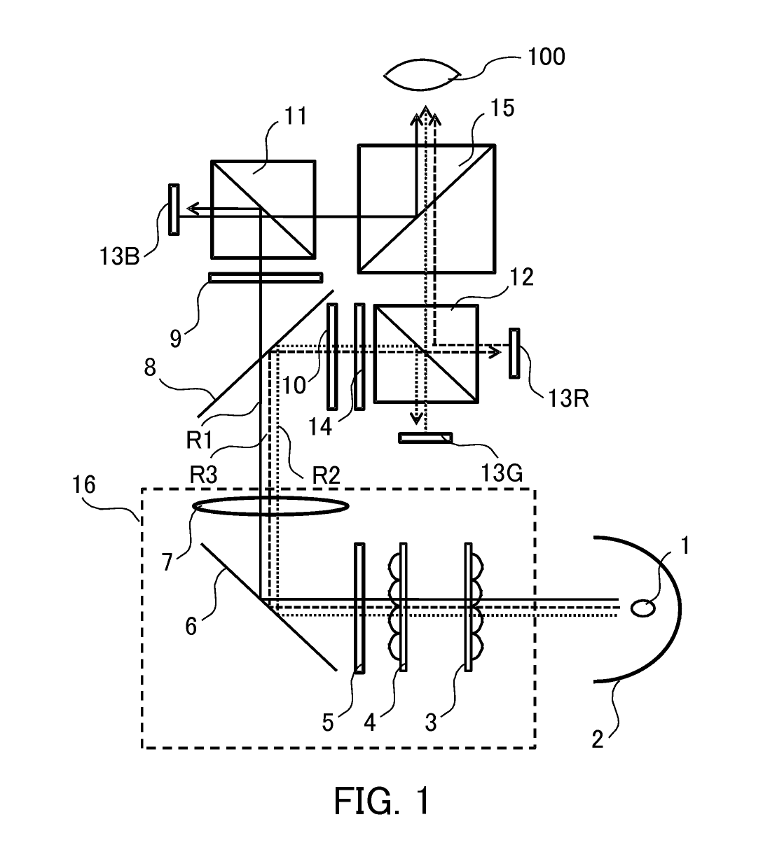

FIG. 1 illustrates a configuration of an image projection apparatus according to a first embodiment of the present invention. In FIG. 1, reference numeral 1 denotes a light source such as a high-pressure mercury discharge tube. Light beams (illumination light) radiated from the light source 1 are converted into collimated light beams by a parabolic reflector 2. The collimated light beams are divided into a plurality of divided light beams by a first fly-eye lens 3 and condensed near a second fly-eye lens 4, and are then converted into S-polarized light by a PS conversion element 5. The divided light beams thus S-polarized are then passed through a first mirror 6 and a condenser lens 7, and then are incident on reflective liquid crystal display elements (reflective liquid crystal panels) 13 (13R, 13G, and 13B). These components through which the collimated light beams pass from the first fly-eye lens 3 to the condenser lens 7 are included in an illumination optical system 16.

The liquid crystal display elements 13R, 13G, and 13B are red-light, green-light, blue-light display elements, respectively, that each reflect incident light and performs image modulation on the light. Reference numeral 8 denotes a dichroic mirror as a first optical path separating unit that transmits blue light (blue-band light) as a first color beam and reflects green light (green-band light) as a second color beam and red light (red-band light) as a third color beam.

Reference numerals 9 and 10 denote a first polarizing plate and a second polarizing plate, respectively, that each transmit S-polarized light and reflect P-polarized light. Reference numeral 11 denotes a first polarizing beam splitter that reflects S-polarized light of the first color beam and transmits P-polarized light thereof. Reference numeral 12 denotes a second polarizing beam splitter that reflects S-polarized light of each of the second color beam and the third color beam and transmits P-polarized light thereof. Reference numeral 14 denotes a wavelength-selective phase plate that converts the third color beam from S-polarized light to P-polarized light. Reference numeral 15 denotes a combining prism that synthesizes the first color beam, the second color beam, and the third color beam that are modulated by a reflective liquid crystal display element 13.

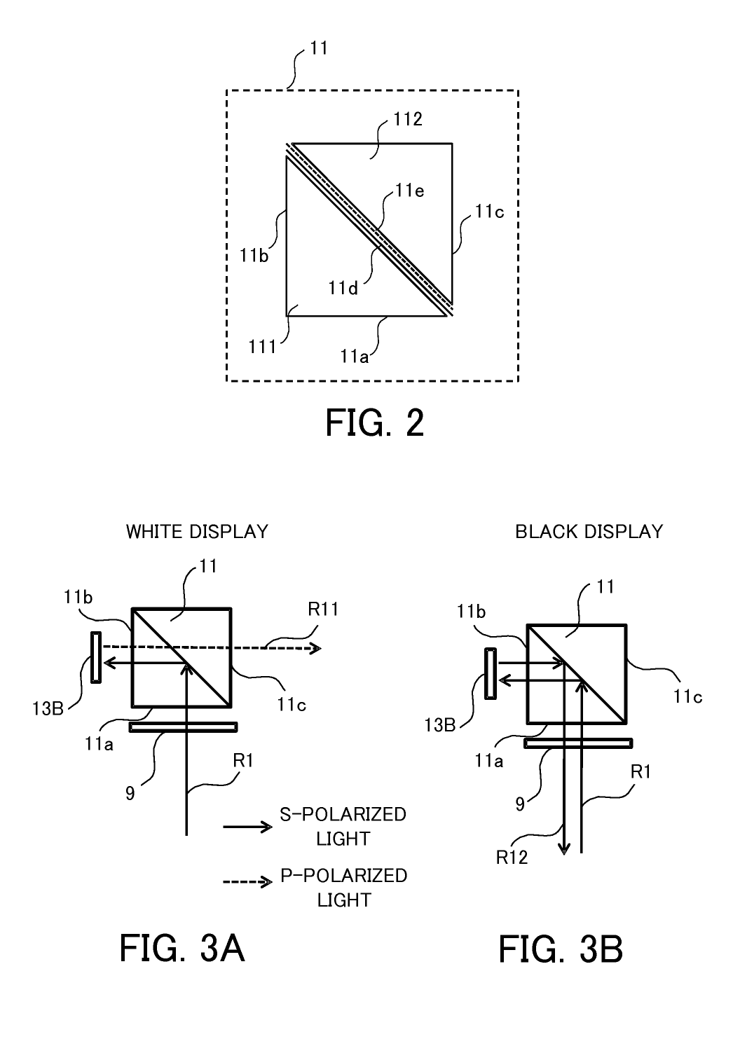

FIG. 2 illustrates a configuration of the first polarizing beam splitter 11. The first polarizing beam splitter 11 is formed by bonding a slant surface of a first right angle prism (first glass member) 111 and a slant surface of a second right angle prism (second glass member formed of the same material as that of the first glass member) 112. These bonded surfaces have a dielectric film as a polarization separating layer (polarization separating film) 11d stacked therebetween, and the first and second right angle prisms are bonded through an adhesion layer (adhesive) 11e.

Reference numeral 11a denotes an incident surface of the polarizing beam splitter on an incident optical path. Reference numeral 11b denotes an exit surface of the polarizing beam splitter on the incident optical path or an incident surface of the polarizing beam splitter on an exit optical path. Reference numeral 11c denotes an exit surface of the polarizing beam splitter on the exit optical path.

More specifically, the incident surface 11a is a surface of the polarizing beam splitter and passed through (intersected) by the illumination light from the light source that enters into the polarizing beam splitter. The exit surface 11b (a first exit surface) is another surface of the polarizing beam splitter and passed through (intersected) by the illumination light that is emitted from the polarizing beam splitter.

When the incident optical path is not such an optical path that perpendicularly passes through the incident surface 11a as illustrated in FIG. 3A, a distance from the incident surface 11a to the exit surface 11b is defined as follows. Assume that an intersecting plane of the incident surface is defined as a plane that is orthogonal to a plane parallel to both of a normal of a member other than the glass member and a normal of the incident surface and that is parallel to the normal of the incident surface. Also, assume that an intersecting plane of the first exit surface is defined as a plane that is orthogonal to a plane parallel to both of the normal of the member other than the glass member and a normal of the exit surface 11b (first exit surface) and that is parallel to the normal of the exit surface 11b. Then, the distance from the incident surface 11a to the exit surface 11b is defined as a sum of a length of the glass member from the incident surface to the member other than the glass member on the incident optical path, perpendicularly projected onto the intersecting plane of the incident surface, and a length of the glass member from the member other than the glass member to the exit surface 11b (first exit surface) on the incident optical path, perpendicularly projected onto the intersecting plane of the first exit surface. The incident optical path is an optical path on which a central light beam of the illumination light entering the polarizing beam splitter propagates.

Thus, the incident optical path is an optical path through which the illumination light passes when travelling from the incident surface 11a to the exit surface 11b. The distance from the incident surface 11a to the exit surface 11b is the sum of a length of the glass member on the incident optical path from the incident surface to the member other than the glass member and a length of the glass member on the incident optical path from the member other than the glass member to the exit surface 11b.

The exit surface 11c (a second exit surface) is another surface of the polarizing beam splitter and passed through (intersected) by light modulated by the reflective liquid crystal display element 13 and emitted from the polarizing beam splitter. Thus, the exit optical path is an optical path through which modulated light passes when travelling from the exit surface 11b to the exit surface 11c.

In this embodiment, the illumination light on the incident optical path is reflected by the polarization separating film and emitted from the polarizing beam splitter without passing through the adhesion layer. The modulated light on the exit optical path is emitted from the polarizing beam splitter after passing through both the polarization separating film and the adhesion layer.

Similarly to the first polarizing beam splitter 11, the second polarizing beam splitter 12 is formed by bonding slant surfaces of right angle prisms. These bonded surfaces have a dielectric film as a polarization separating film stacked therebetween, and the right angle prisms are bonded through an adhesive.

### Optical Effects

### 1) First Color Beam (Blue-Band Light)

Next follows a description of an optical effect of light passing through the illumination optical system 16. First, optical effect of white display and black display of the first color beam (a light beam R1) as blue-band light will be described. FIGS. 3A and 3B illustrate the optical effect of white display and black display of the first color beam. In white display illustrated in FIG. 3A, the S-polarized light of the first color beam having passed through the illumination optical system 16 is transmitted through the dichroic mirror 8 and the first polarizing plate 9. Then, the first polarizing plate 9 reflects the P-polarized light included in the first color beam as an unnecessary light component, so that the fraction of the S-polarized light is increased.

The S-polarized light of the first color beam transmitted through the first polarizing plate 9 is reflected by the first polarizing beam splitter 11 and is incident on the blue-light (blue-band light) reflective liquid crystal display element 13B. Image light modulated (converted into P-polarized light as a predetermined polarization component) by the reflective liquid crystal display element 13B is transmitted through the first polarizing beam splitter 11 and guided through the combining prism 15 to a screen (projection surface) by a projection lens 100 as a projection optical system.

In the black display illustrated in FIG. 3B, S-polarized light of the illumination light incident on the liquid crystal display element 13B is reflected by the liquid crystal display element 13B without being modulated (without being converted into P-polarized light). The S-polarized light reflected by the liquid crystal display element 13B is reflected by the first polarizing beam splitter 11, transmitted through the dichroic mirror 8, and is guided to the illumination optical system 16.

### 2) Second Color Beam (Green-Band Light)

Next follows a description of an optical effect of the second color beam (a light beam R2) as green-band light. In white display, S-polarized light of the second color beam having passed through the illumination optical system 16 is reflected by the dichroic mirror 8 and transmitted through the second polarizing plate 10. The second polarizing plate 10 reflects P-polarized light included in the second color beam and the third color beam as unnecessary light components, so that the fraction of the S-polarized light is increased. The S-polarized light of the second color beam transmitted through the second polarizing plate 10 is transmitted through a wavelength selecting phase plate 14, reflected by the second polarizing beam splitter 12, and incident on the green-light liquid crystal display element 13G.

Image light modulated (light converted into P-polarized light) by the liquid crystal display element 13G is transmitted through the second polarizing beam splitter 12 and guided through the combining prism 15 to the screen by the projection lens 100.

In black display, the S-polarized light of the illumination light incident on the liquid crystal display element 13G is reflected by the liquid crystal display element 13G without being modulated (without being converted into P-polarized light). The S-polarized light reflected by the liquid crystal display element 13G is reflected by the second polarizing beam splitter 12 and the dichroic mirror 8, and guided to the illumination optical system 16.

### 3) Third Color Beam (Red-Band Light)

Next follows a description of an optical effect of the third color beam (a light beam R3) as red-band light. In white display, the S-polarized light of the second color beam having passed through the illumination optical system 16 is reflected by the dichroic mirror 8 and transmitted through the second polarizing plate 10. The S-polarized light of the second color beam transmitted through the second polarizing plate 10 is converted into P-polarized light by the wavelength selecting phase plate 14, transmitted through the second polarizing beam splitter 12, and incident on the red-light liquid crystal display element 13R. Image light modulated (light converted into S-polarized light) by the liquid crystal display element 13R is reflected by the second polarizing beam splitter 12 and guided through the combining prism 15 to the screen by the projection lens 100.

In black display, the P-polarized light of the illumination light incident on the liquid crystal display element 13R is reflected by the liquid crystal display element 13R without being modulated (without being converted into S-polarized light). The P-polarized light reflected by the liquid crystal display element 13R is transmitted through the second polarizing beam splitter 12, converted into S-polarized light by the wavelength-selective phase plate 14, transmitted through the second polarizing plate 10, reflected by the dichroic mirror 8, and guided to the illumination optical system 16.

### Generation of Phase Difference in Polarizing Beam Splitter

The amount of heat generated in the polarizing beam splitter varies depending on the absorptivities (light absorptivities) of each right angle prism (hereinafter, simply referred to as the prism) made of glass, the polarization separating layer (polarization separating film), and the adhesion layer (adhesive). The temperatures of the prism, the polarization separating film, and the adhesive increase in accordance with light absorption. The heat generated by the light absorption is transferred to the glass prism and produces a temperature distribution across the prism. The temperature distribution thus produced causes distortion in the prism in accordance with a linear expansion coefficient. The distortion generates stress in the prism in accordance with a Young's modulus. As a result, a phase difference (birefringence) is generated in accordance with the stress and a photoelastic coefficient.

Thus, the phase difference can be reduced by having:

1. Small photoelastic coefficient
2. Small Young's modulus
3. Small linear expansion coefficient
4. Small temperature gradient of the prism

The small temperature gradient of the prism in 4. can be achieved by achieving:

4-1. High thermal conductivity
4-2. Small light absorption by the glass member
4-3. Small light absorption by the polarization separating film and the adhesive

In other words, the phase difference is proportional to the linear expansion coefficient, the Young's modulus, the photoelastic coefficient, and the light absorption of the prisms, and is inversely proportional to the thermal conductivity. The light absorption of the prisms is a total absorption by the glass members and members (the polarization separating film and the adhesive) other than the glass members, and is wavelength-dependent.

Typically, the light absorption by the glass members and the members (the polarization separating film and the adhesive) other than the glass members is larger at shorter wavelengths in a visible light range, and thus the polarizing beam splitter used for blue-band light is the primary cause of black floating and color unevenness due to photoelasticity.

It was found that an image projection apparatus with a native contrast ratio of 5000:1 or less, which depends on the amount of leakage light, suffers insignificant generation of black floating and color unevenness due to photoelasticity in practical use when a condition below is satisfied. The leakage light refers to light that should be transmitted through the polarizing beam splitter but is reflected, or light that should be reflected by the polarizing beam splitter but is transmitted.

The condition is such that the first polarizing beam splitter 11, which is a polarizing beam splitter for blue-band light as the first color beam included in the illumination light, includes a lead-free glass member and satisfies conditional expressions below.

50<α*E*β*A/κ<300 (1)

A=(1−T̂(L/0.01))+M (2)

T=(T1+T2)/2 (3)

In the expressions above, a represents the linear expansion coefficient (10⁻⁷/K) of the glass member, E represents the Young's modulus (10⁹ Pa) of the glass member, β represents the photoelastic coefficient (10⁻¹²/Pa) of the glass member, and A represents the absorptivity of the polarizing beam splitter for blue-band light. κ represents the thermal conductivity (W/m/K) of the glass member. L represents a distance from the incident surface of the polarizing beam splitter for blue-band light to the first exit surface thereof, and M represents the absorptivity of the member other than the glass member on the incident optical path in the polarizing beam splitter for blue-band light at a wavelength of 440 nm.

T1 represents the transmissivity of the glass member having a thickness of 10 mm for light having a wavelength of 420 nm, and T2 represents the transmissivity of the glass member having a thickness of 10 mm for light having a wavelength of 460 nm.

When the polarizing beam splitter for blue-band light includes the polarization separating layer and the adhesion layer between the first and second glass members, the absorptivity M of the member other than the glass members is the absorptivity of the polarization separating layer and the adhesion layer.

Expression (1) expresses that the phase difference is proportional to the linear expansion coefficient α, the Young's modulus E, and the photoelastic coefficient β of the lead-free glass members, and the absorptivity A of the polarizing beam splitter for blue-band light, and is inversely proportional to the thermal conductivity κ. Satisfying the numerical value condition of Expression (1) can reduce black floating and color unevenness due to photoelastic.

The first term of Expression (2) represents the absorptivity, which is calculated from the transmissivity T of the glass members having a thickness of 10 mm, across the distance L from the incident surface 11a to the exit surface 11b of the polarizing beam splitter for blue-band light.

The absorptivity M of the member other than the glass members as the second term of Expression (2) is limited to the incident optical path because black floating and color unevenness due to photoelastic are more significant in black display than in white display. In black display, as illustrated in FIG. 3B, the incident light beam R1 on the reflective liquid crystal panel and an exit light beam R12 emitted by the reflective liquid crystal panel pass through an identical optical path, which allows the absorptivity of the member other than the glass members to be limited to the incident optical path. Thus, the absorptivity M is the absorptivity of the member other than the glass members in the polarizing beam splitter for blue-band light in black display.

Next follows a description of a more desirable condition. The numerical value range of Expression (1) is desirably set as follows.

100<α*E*βA/κ<300 (4)

Satisfying this condition can further reduce black floating and color unevenness.

The polarizing beam splitter more desirably satisfies Expression (4a) below.

100<α*E*βA/κ<250 (4a)

With Expressions (1), (4), and (4a) satisfied, the absorptivity M desirably satisfies a conditional expression below.

0<M<0.03 (5)

The absorptivity M beyond the upper limit of Expression (5) leads to a locally high amount of heat generated near the polarization separating layer and the adhesion layer, which results in a large temperature distribution of the polarizing beam splitter. This increases the phase difference, and hence increases black floating and color unevenness.

To further reduce the absorption, as illustrated in FIG. 2, the adhesion layer 11e is disposed between the polarization separating layer 11d and the exit surface 11c of the polarizing beam splitter 11. In other words, the polarization separating layer 11d is disposed between the adhesion layer 11e and the incident surface 11b. Such an arrangement suppresses light passing through the adhesion layer 11e in black display, and thus can achieve substantially no absorption by the adhesion layer 11e in black display and reduce heat caused by the absorption. In other words, the illumination light on the incident optical path is not passed through the adhesion layer 11e but is reflected by and emitted from the polarization separating layer 11d. The image light (light modulated by the liquid crystal display element 13) on the exit optical path is passed through the polarization separating layer 11d and the adhesion layer 11e and emitted from the polarizing beam splitter.

Since black floating and color unevenness are more significant in black display than in white display, Expression (1) is limited to the absorptivity for the incident optical path. However, when display is switched from a bright image to a dark image such as from white display to black display, the temperature distribution right after the switching to the dark image is that of the bright image. This is likely to generate black floating and color unevenness due to photoelastic. Thus, to suppress black floating and color unevenness right after image change such as the switching from a bright image to a dark image as well as in constant black display, conditional expressions below are desirably satisfied in addition to the conditional expression of Expression (1).

50<α*E*β*C/κ<400 (6)

C=(1−T̂(L/0.01))+H (7)

H=(H1+H2)/2

In the expressions, H1 represents the absorptivity of the member other than the glass members on the incident optical path in the polarizing beam splitter for blue-band light at a wavelength of 440 nm, and H2 represents the absorptivity of the member other than the glass members on the exit optical path in the polarizing beam splitter for blue-band light at a wavelength of 440 nm. Thus, H represents the absorptivity of the member other than the glass members in the polarizing beam splitter for blue-band light in white display.

The numerical value range of Expression (7) is more desirably set as follows.

100<α*E*β*C/κ<400 (8)

This can further reduce black floating and color unevenness.

The polarizing beam splitter more desirably satisfies Expression (8a).

100<α*E*βA/κ<300 (8a)

With Expressions (6), (8), and (8a) satisfied, the absorptivity H desirably satisfies a conditional expression below.

0<H<0.03 (9)

The absorptivity H beyond the upper limit of Expression (9) leads to a locally high amount of heat generated near the polarization separating layer and the adhesion layer, which results in a large temperature distribution of the polarizing beam splitter. This increases the phase difference, and hence increases black floating and color unevenness.

With Expressions (6) and (8) satisfied, the photoelastic coefficient β desirably satisfies a conditional expression below.

0.4<β<1 (10)

When the polarizing beam splitter for blue-band light is dedicated for blue-band light as in this embodiment, the polarization separating layer and the adhesion layer only need to be appropriate for blue-band light, which facilitates fabricating of an accurate polarizing beam splitter. Moreover, a desirable image projection apparatus can be obtained when 90% or more of the energy of a light beam entering the polarizing beam splitter for blue-band light is the energy of a blue-band light beam having a wavelength of 510 nm or less.

### Second Embodiment

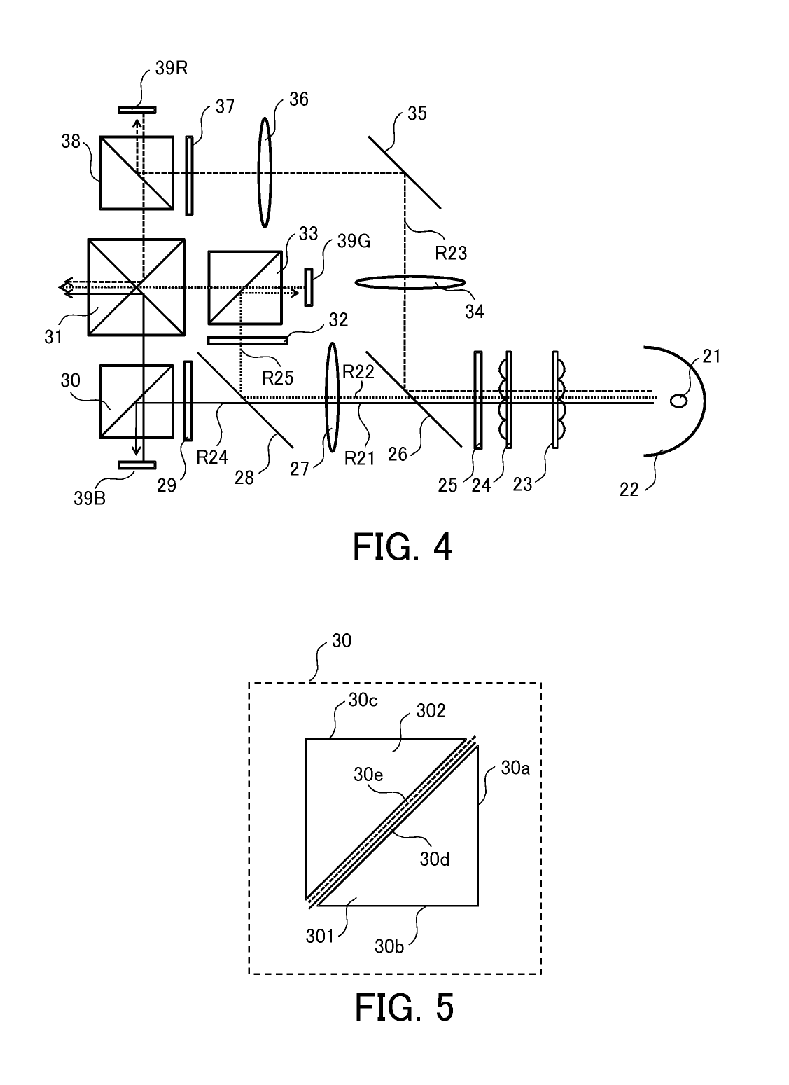

FIG. 4 illustrates a configuration of an image projection apparatus according to a second embodiment of the present invention. In this embodiment, a dedicated polarizing beam splitter is provided for each color.

In FIG. 4, reference numeral 21 denotes a light source such as a high-pressure mercury discharge tube, reference numeral 22 denotes a parabolic reflector, reference numeral 23 denotes a first fly-eye lens, reference numeral 24 denotes a second fly-eye lens, reference numeral 25 denotes a PS conversion element, and reference numeral 26 denotes a first dichroic mirror. Reference numeral 27 denotes a first condenser lens, reference numeral 28 denotes a second dichroic mirror, reference numeral 29 denotes a first polarizing plate, reference numeral 30 denotes a first polarizing beam splitter, and reference numeral 31 denotes a cross dichroic prism.

Reference numeral 32 denotes a second polarizing plate, reference numeral 33 denotes a second polarizing beam splitter, reference numeral 34 denotes a relay lens, reference numeral 35 denotes a mirror, reference numeral 36 denotes a second condenser lens, reference numeral 37 denotes a third polarizing plate, and reference numeral 38 denotes a third polarizing beam splitter. Reference numerals 39R, 39G, and 39B respectively denote red-light, green-light, blue-light reflective liquid crystal display elements that each perform image modulation on incident light and emit modulated light.

FIG. 5 illustrates a configuration of the first polarizing beam splitter 30. The first polarizing beam splitter 30 is formed by bonding a slant surface of a first right angle prism 301 and a slant surface of a second right angle prism 302. These bonded surfaces have a dielectric film as a polarization separating film 30d stacked therebetween, and the first and second right angle prisms are bonded through an adhesive 30e.

Reference numeral 30a denotes an incident surface of the polarizing beam splitter on an incident optical path. Reference numeral 30b denotes an exit surface of the polarizing beam splitter on the incident optical path or an incident surface of the polarizing beam splitter on an exit optical path. Reference numeral 30c denotes an exit surface of the polarizing beam splitter on the exit optical path.

Light beams radiated from the light source 21 are converted into collimated light beams by the parabolic reflector 22. The collimated light beams are divided into a plurality of divided light beams by the first fly-eye lens 23. The divided light beams are condensed near the second fly-eye lens 24 and converted into S-polarized light by the PS conversion element 25. The divided light beams thus S-polarized are separated into blue (blue-band) light (light beam R21) as a first color beam by the first dichroic mirror 26, green (green-band) light (light beam R22) as a second color beam, and red (red-band) light (light beam R23) as a third color beam.

Then, the first and second color beams are incident on the blue-light reflective liquid crystal display element 39B and the green-light reflective liquid crystal display element 39G through the first condenser lens 27 in a superimposing manner. The third color beam is incident on the red-light reflective liquid crystal display element 39R through the relay lens 34, the mirror 35, and the second condenser lens 36 in a superimposing manner.

Then, the first and second color beams passing through the first condenser lens 27 are separated by the second dichroic mirror 28 into the first color beam (light beam R24) and the second color beam (light beam R25). The first color beam is transmitted through the first polarizing plate 29 that transmits only S-polarized light, reflected by the first polarizing beam splitter 30, and incident on the blue-light reflective liquid crystal display element 39B. Then, image light modulated (light converted into P-polarized light) by the reflective liquid crystal display element 39B is transmitted through the first polarizing beam splitter 30 and guided through the cross dichroic prism 31 as a combining prism to a screen by the projection lens 100.

The second color beam is transmitted through the second polarizing plate 32 that transmits only S-polarized light, reflected by the second polarizing beam splitter 33, and incident on the green-light reflective liquid crystal display element 39G. Image light modulated (light converted into P-polarized light) by the reflective liquid crystal display element 39G is transmitted through the second polarizing beam splitter 33 and guided through the cross dichroic prism 31 to the screen by the projection lens 100.

The third color beam is transmitted through the third polarizing plate 37 that transmits only S-polarized light, reflected by the third the polarizing beam splitter 38, and incident on the red-light reflective liquid crystal display element 39R. Image light modulated (light converted into P-polarized light) by the reflective liquid crystal display element 39R is transmitted through the third the polarizing beam splitter 38 and guided through the cross dichroic prism 31 to the screen by the projection lens 100.

### Optical Effect of White Display and Black Display

Next follows a description of an optical effect of white display and black display of the first color beam (light beam R24). In white display, the S-polarized light of the first color beam transmitted through the second dichroic mirror 28 is transmitted through the first polarizing plate 29 that reflects P-polarized light included in the first color beam as an unnecessary light component, so that the fraction of the S-polarized light is increased.

Then, the S-polarized light of the first color beam transmitted through the first polarizing plate 29 is reflected by the first polarizing beam splitter 30 and incident on the blue-light reflective liquid crystal display element 39B. Image light modulated (light converted into P-polarized light) by the reflective liquid crystal display element 39B is transmitted through the first polarizing beam splitter 30 and guided through the cross dichroic prism. 31 to the screen by the projection lens 100.

In black display, the S-polarized light of the illumination light incident on the reflective liquid crystal display element 39B is reflected by the reflective liquid crystal display element 39B without being modulated (without being converted into S-polarized light). The S-polarized light reflected by the reflective liquid crystal display element 39B is reflected by the first polarizing beam splitter 30, transmitted through the second dichroic mirror 28, and guided toward the light source.

The optical effect of white display and black display of the second color beam (light beam R25) and the third color beam (light beam. R23) is based on the same as that of the first color beam (light beam R24).

Similarly to the first embodiment, in this embodiment, satisfying Expressions (1) to (3) can reduce black floating and color unevenness due to photoelastic. Desirable conditions are the same as those in the first embodiment.

### Effect of First and Second Embodiments

As described above, the first and second embodiments each provide a lead-free glass polarizing beam splitter capable of reducing black floating and color unevenness.

### Numerical Examples

Next follows lists of numerical examples corresponding to the first and second embodiments. The numerical examples 1, 5, and 9 are obtained by using S-FPL51 manufactured by OHARA Inc., and the numerical examples 2, 6, and 10 are obtained by using S-FPL53 manufactured by OHARA Inc. The numerical examples 3, 7, and 11 are obtained by using FCD505 manufactured by HOYA CORPORATION, and the numerical examples 4, 8, and 12 are obtained by using S-FPM2 manufactured by OHARA Inc. In the numerical examples, L is 0.02 m, and M and H are different between the numerical examples.

The polarizing beam splitter according to each embodiment of the present invention may be made of any lead-free glass material other than the material (lead-free glass material) of the glass members in the numerical examples as long as Expression (1) is satisfied.

### Numerical Example 1

Glass material: S-FPL51

| | | | | | | | T | T |
|---|---|---|---|---|---|---|---|---|
| L [m] | M | H | α | E | β | κ | (420) | (460) |
| 0.02 | 0.01 | 0.02 | 131.0 | 72.7 | 0.740 | 0.780 | 0.994 | 0.996 |

| | |
|---|---|
| Expression (1) | 180 |
| Expression (6) | 273 |

### Numerical Example 2

Glass material: S-FPL53

| | | | | | | | T | T |
|---|---|---|---|---|---|---|---|---|
| L [m] | M | H | α | E | β | κ | (420) | (460) |
| 0.02 | 0.01 | 0.02 | 145.0 | 69.1 | 0.570 | 0.857 | 0.995 | 0.996 |

| | |
|---|---|
| Expression (1) | 126 |
| Expression (6) | 193 |

### Numerical Example 3

Glass material: FCD505

| | | | | | | | T | T |
|---|---|---|---|---|---|---|---|---|
| L [m] | M | H | α | E | β | κ | (420) | (460) |
| 0.02 | 0.01 | 0.02 | 120.0 | 75.0 | 0.410 | 0.629 | 0.988 | 0.992 |

| | |
|---|---|
| Expression (1) | 175 |
| Expression (6) | 234 |

### Numerical Example 4

Glass material: S-FPM2

| | | | | | | | T | T |
|---|---|---|---|---|---|---|---|---|
| L [m] | M | H | α | E | β | κ | (420) | (460) |
| 0.02 | 0.01 | 0.02 | 117.0 | 75.7 | 0.510 | 0.624 | 0.989 | 0.992 |

| | |
|---|---|
| Expression (1) | 209 |
| Expression (6) | 282 |

### Numerical Example 5

Glass material: S-FPL51

| | | | | | | | T | T |
|---|---|---|---|---|---|---|---|---|
| L [m] | M | H | α | E | β | κ | (420) | (460) |
| 0.02 | 0.02 | 0.03 | 131.0 | 72.7 | 0.740 | 0.780 | 0.994 | 0.996 |

| | |
|---|---|
| Expression (1) | 271 |
| Expression (6) | 361 |

### Numerical Example 6

Glass material: S-FPL53

| | | | | | | | T | T |
|---|---|---|---|---|---|---|---|---|
| L [m] | M | H | α | E | β | κ | (420) | (460) |
| 0.02 | 0.02 | 0.03 | 145.0 | 69.1 | 0.570 | 0.857 | 0.995 | 0.996 |

| | |
|---|---|
| Expression (1) | 193 |
| Expression (6) | 260 |

### Numerical Example 7

Glass material: FCD505

| | | | | | | | T | T |
|---|---|---|---|---|---|---|---|---|
| L [m] | M | H | α | E | β | κ | (420) | (460) |
| 0.02 | 0.02 | 0.03 | 120.0 | 75.0 | 0.410 | 0.629 | 0.988 | 0.992 |

| | |
|---|---|
| Expression (1) | 234 |
| Expression (6) | 293 |

### Numerical Example 8

Glass material: S-FPM2

| | | | | | | | T | T |
|---|---|---|---|---|---|---|---|---|
| L [m] | M | H | α | E | β | κ | (420) | (460) |
| 0.02 | 0.02 | 0.03 | 117.0 | 75.7 | 0.510 | 0.624 | 0.989 | 0.992 |

| | |
|---|---|
| Expression (1) | 282 |
| Expression (6) | 354 |

### Numerical Example 9

Glass material: S-FPL51

| | | | | | | | T | T |
|---|---|---|---|---|---|---|---|---|
| L [m] | M | H | α | E | β | κ | (420) | (460) |
| 0.02 | 0.015 | 0.025 | 131.0 | 72.7 | 0.740 | 0.780 | 0.994 | 0.996 |

| | |
|---|---|
| Expression (1) | 226 |
| Expression (6) | 316 |

### Numerical Example 10

Glass material: S-FPL53

| | | | | | | | T | T |
|---|---|---|---|---|---|---|---|---|
| L [m] | M | H | α | E | β | κ | (420) | (460) |
| 0.02 | 0.015 | 0.025 | 145.0 | 69.1 | 0.570 | 0.857 | 0.995 | 0.996 |

| | |
|---|---|
| Expression (1) | 160 |
| Expression (6) | 226 |

### Numerical Example 11

Glass material: FCD505

| | | | | | | | T | T |
|---|---|---|---|---|---|---|---|---|
| L [m] | M | H | α | E | β | κ | (420) | (460) |
| 0.02 | 0.015 | 0.025 | 120.0 | 75.1 | 0.410 | 0.629 | 0.988 | 0.992 |

| | |
|---|---|
| Expression (1) | 205 |
| Expression (6) | 263 |

### Numerical Example 12

Glass material: S-FPM2

| | | | | | | | T | T |
|---|---|---|---|---|---|---|---|---|
| L [m] | M | H | α | E | β | κ | (420) | (460) |
| 0.02 | 0.015 | 0.025 | 117.0 | 75.7 | 0.510 | 0.624 | 0.989 | 0.992 |

| | |
|---|---|
| Expression (1) | 245 |
| Expression (6) | 318 (Modified example) |

### Modified Example 1

In each of the embodiments described above, the polarizing beam splitter for blue-band light is dedicated for blue-band light, but may be shared by blue-band light and light in other bands (red-band light, for example). Thus, the present invention is applicable to an image projection apparatus including a polarizing beam splitter that blue-band light and red-band light enter and a polarizing beam splitter that only green-band light enters.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-095055, filed May 2, 2014 and Japanese Patent Application No. 2015-084533, filed Apr. 16, 2015, which are hereby incorporated by reference herein in their entirety.

What is claimed is:

1. An image projection apparatus comprising:
a reflective display element configured to modulate illumination light from a light source and to emit the light thus modulated;
a projection optical system configured to project the light thus modulated onto a projection surface; and
a polarizing beam splitter configured to guide the illumination light to the reflective display element and to guide a predetermined polarization component of the light thus modulated to the projection optical system;
wherein the polarizing beam splitter is a polarizing beam splitter that blue-band light enters, includes a lead-free glass member, and satisfies conditional expressions below:
50<α*E*β*A/κ<300
A=(1−T̂(L/0.01))+M
T=(T1+T2)/2
where α represents a linear expansion coefficient (10⁻⁷/K) of the glass member, E represents a Young's modulus (10⁹ Pa) of the glass member, β represents a photoelastic coefficient (10⁻¹²/Pa) of the glass member, A represents an absorptivity of the polarizing beam splitter for blue-band light, κ represents a thermal conductivity (W/mK) of the glass member, L represents a distance from an incident surface to a first exit surface of the polarizing beam splitter, M represents an absorptivity of a member other than the glass member on an incident optical path in the polarizing beam splitter for light having a wavelength of 440 nm, T1 represents a transmissivity of the glass member having a thickness of 10 mm for light having a wavelength of 420 nm, and T2 represents a transmissivity of the glass member having a thickness of 10 mm for light having a wavelength of 460 nm,
wherein the incident surface is a surface of the polarizing beam splitter, which the illumination light entering the polarizing beam splitter from the light source passes through,
wherein the first exit surface is another surface of the polarizing beam splitter, which the illumination light emitted from the polarizing beam splitter passes through,
wherein the incident optical path is an optical path on which the illumination light travels from the incident surface to the first exit surface, and
wherein the distance from the incident surface to the first exit surface is a sum of a length of the glass member from the incident surface to the member other than the glass member on the incident optical path, and a length of the glass member from the member other than the glass member to the first exit surface on the incident optical path.

2. The image projection apparatus according to claim 1, wherein the polarizing beam splitter includes a first glass member, a second glass member, and a polarization separating layer and an adhesion layer that are disposed between the first and second glass members, and an absorptivity of the member other than the glass members is an absorptivity of the polarization separating layer and the adhesion layer.

3. The image projection apparatus according to claim 2, wherein the polarization separating layer is disposed between the adhesion layer and the incident surface.

4. The image projection apparatus according to claim 1, wherein a conditional expression below is satisfied:
100<α*E*βA/κ<300.

5. The image projection apparatus according to claim 1, wherein a conditional expression below is satisfied:
0<M<0.03.

6. The image projection apparatus according to claim 1,
wherein a conditional expression below is satisfied:
50<α*E*β*C/κ<400
C=(1−T̂(L/0.01))+H
H=(H1+H2)/2
where H1 represents an absorptivity of the member other than the glass member on the incident optical path in the polarizing beam splitter for blue-band light having a wavelength of 440 nm, and H2 represents an absorptivity of the member other than the glass member on an exit optical path in the polarizing beam splitter for blue-band light having a wavelength of 440 nm, and
wherein the exit optical path is an optical path on which the light thus modulated travels from the first exit surface to a second exit surface that is a surface of the polarizing beam splitter, which the light thus modulated that is emitted from the polarizing beam splitter passes through.

7. The image projection apparatus according to claim 6, wherein a conditional expression below is satisfied:
100<α*E*β*C/κ<400.

8. The image projection apparatus according to claim 6, wherein a conditional expression below is satisfied:
0<H<0.03.

9. The image projection apparatus according to claim 1, wherein 90% or more of energy of a light beam entering the polarizing beam splitter is energy of a blue-band light beam having a wavelength of 510 nm or less.

10. The image projection apparatus according to claim 1, wherein the polarizing beam splitter is dedicated for blue-band light.
